(19) United States
(12) Patent Application Publication
(10) Pub. No.: US 2020/0189820 A1
(43) Pub. Date: Jun. 18, 2020

(54) Carrier For Containers

(71) Applicant: Graphic Packaging International, LLC, Atlanta, GA (US)

(72) Inventor: Brian Smalley, Bristol (GB)

(21) Appl. No.: 16/426,060

(22) Filed: May 30, 2019

Related U.S. Application Data
(60) Provisional application No. 62/779,689, filed on Dec. 14, 2018.
(60) Provisional application No. 62/783,752, filed on Dec. 21, 2018.
(60) Provisional application No. 62/796,830, filed on Jan. 25, 2019.
(60) Provisional application No. 62/797,585, filed on Jan. 28, 2019.
(60) Provisional application No. 62/810,015, filed on Feb. 25, 2019.
(60) Provisional application No. 62/814,412, filed on Mar. 6, 2019.
(60) Provisional application No. 62/817,120, filed on Mar. 12, 2019.
(60) Provisional application No. 62/841,449, filed on May 1, 2019.

(51) Int. Cl. B65D 71/44; B31B 50/00; B31B 50/02; B31B 50/26; B31B 50/52; B31B 50/62; B31B 50/86; B31B 50/20

(52) U.S. Cl. CPC B65D 71/44; B31B 50/006; B31B 50/02; B31B 50/20; B31B 50/52; B31B 50/624; B31B 50/86; B31B 50/262

(57) ABSTRACT

A carrier for holding a plurality of containers includes a plurality of panels. The plurality of panels includes at least one central panel for being attached to at least one container of the plurality of containers. The plurality of panels further includes at least one attachment panel foldably connected to the at least one central panel, the at least one attachment panel comprises a plurality of container retention features for at least partially receiving a top portion of a respective container of the plurality of containers. The plurality of panels further includes at least one handle panel foldably connected to the at least one central panel for forming a handle of the carrier.

### CROSS-REFERENCE TO RELATED APPLICATIONS

This application claims the benefit of each of U.S. Provisional Patent Application No. 62/779,689, filed on Dec. 14, 2018, U.S. Provisional Patent Application No. 62/783,752, filed on Dec. 21, 2018, U.S. Provisional Patent Application No. 62/796,830, filed on Jan. 25, 2019, U.S. Provisional Patent Application No. 62/797,585, filed on Jan. 28, 2019, and U.S. Provisional Patent Application No. 62/810,015, filed on Feb. 25, 2019, U.S. Provisional Patent Application No. 62/814,412, filed on Mar. 6, 2019, U.S. Provisional Patent Application No. 62/817,120, filed on Mar. 12, 2019, and U.S. Provisional Patent Application No. 62/841,449, filed on May 1, 2019.

### INCORPORATION BY REFERENCE

The disclosures of each of U.S. Provisional Patent Application No. 62/779,689, filed on Dec. 14, 2018, U.S. Provisional Patent Application No. 62/783,752, filed on Dec. 21, 2018, U.S. Provisional Patent Application No. 62/796,830, filed on Jan. 25, 2019, U.S. Provisional Patent Application No. 62/797,585, filed on Jan. 28, 2019, and U.S. Provisional Patent Application No. 62/810,015, filed on Feb. 25, 2019, U.S. Provisional Patent Application No. 62/814,412, filed on Mar. 6, 2019, U.S. Provisional Patent Application No. 62/817,120, filed on Mar. 12, 2019, and U.S. Provisional Patent Application No. 62/841,449, filed on May 1, 2019, are hereby incorporated by reference for all purposes as if presented herein in their entirety.

### BACKGROUND OF THE DISCLOSURE

The present disclosure generally relates to cartons or carriers for holding, displaying, and/or transporting containers.

### SUMMARY OF THE DISCLOSURE

According to one aspect of the disclosure, a carrier for holding a plurality of containers comprises a plurality of panels that comprises at least one central panel, at least one attachment panel, and at least one handle panel. The at least one central panel is for being attached to at least one container of the plurality of containers. The at least one attachment panel is foldably connected to the at least one central panel, and the at least one attachment panel comprises a plurality of container retention features for at least partially receiving a top portion of a respective container of the plurality of containers. The at least one handle panel is foldably connected to the at least one central panel for forming a handle of the carrier.

A blank for forming a carrier for holding a plurality of containers comprises a plurality of panels that comprises at least one central panel, at least one attachment panel, and at least one handle panel. The at least one central panel is for being attached to at least one container of the plurality of containers when the carrier is formed from the blank. The at least one attachment panel is foldably connected to the at least one central panel, and the at least one attachment panel comprises a plurality of container retention features for at least partially receiving a top portion of a respective container of the plurality of containers when the carrier is formed from the blank. The at least one handle panel is foldably connected to the at least one central panel for forming a handle of the carrier formed from the blank.

According to another aspect of the disclosure, a method of forming a carrier for holding a plurality of containers comprises obtaining a blank comprising a plurality of panels, the plurality of panels comprising at least one central panel, at least one attachment panel foldably connected to the at least one central panel, the at least one attachment panel comprises a plurality of container retention features, and at least one handle panel foldably connected to the at least one central panel for forming a handle of the carrier. The method further comprises positioning the at least one central panel between adjacent containers of the plurality of containers. The method further comprises attaching the at least one central panel to at least one container of the plurality of containers.

According to another aspect of the disclosure, a package comprises a plurality of containers and a carrier for holding the plurality of containers. The carrier comprises a plurality of panels that comprises at least one central panel, at least one attachment panel, and at least one handle panel. The at least one central panel is attached to at least one container of the plurality of containers. The at least one attachment panel is foldably connected to the at least one central panel, and the at least one attachment panel comprises a plurality of container retention features at least partially receiving a top portion of a respective container of the plurality of containers. The at least one handle panel is foldably connected to the at least one central panel for forming a handle of the carrier.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an outer surface of a blank for forming a carrier according to a first exemplary embodiment of the disclosure.

FIG. 2 is a perspective view of a partially folded configuration of a carrier formed from the blank of FIG. 1.

FIG. 3 is a perspective view of another partially folded configuration of a carrier formed from the blank of FIG. 1.

FIG. 4 is a perspective view of a package including a carrier formed from the blank of FIG. 1 and in a first configuration according to the first exemplary embodiment of the disclosure.

FIG. 5 is a perspective view of the package and carrier of FIG. 4 in a second configuration.

FIG. 6 is a plan view of an outer surface of a blank for forming a carrier according to a second exemplary embodiment of the disclosure.

FIG. 7 is a perspective view of a partially folded configuration of a carrier formed from the blank of FIG. 6.

FIG. 8 is a perspective view of a carrier formed from the blank of FIG. 6 according to the second exemplary embodiment of the disclosure.

FIG. 9 is another perspective view of the carrier of FIG. 8

FIG. 10 is a perspective view of a package including the carrier of FIG. 8 in a first configuration.

FIG. 11 is another perspective view of the package and carrier of FIG. 10 in the first configuration.

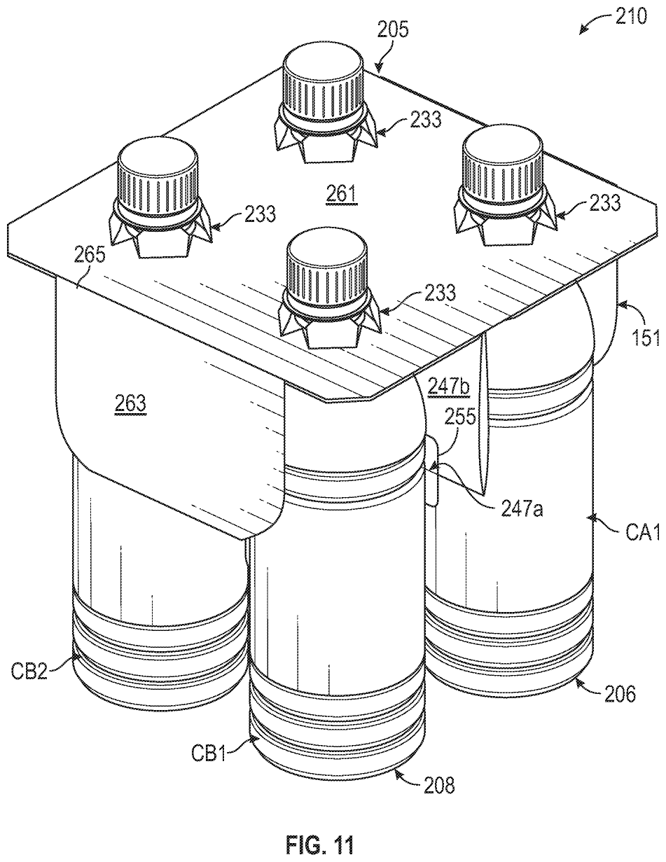

FIG. 12 is a perspective view of the package and carrier of FIG. 10 in a second configuration.

FIG. 13 is a plan view of an outer surface of a blank for forming a carrier according to a third exemplary embodiment of the disclosure.

Corresponding parts are designated by corresponding reference numbers throughout the drawings.

### DETAILED DESCRIPTION OF THE EXEMPLARY EMBODIMENTS

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

Carriers according to the present disclosure can accommodate containers of numerous different shapes. For the purpose of illustration and not for the purpose of limiting the scope of the disclosure, the following detailed description describes beverage containers (e.g., plastic bottles) at least partially disposed within the carrier embodiments. Carriers described herein can also be configured to accommodate containers of food items, for example, canned food items, without departing from the disclosure. In this specification, the terms “lower,” “bottom,” “upper,” “top,” “front,” and “back” indicate orientations determined in relation to fully erected carriers.

As described herein, carriers may be formed by multiple overlapping panels, end flaps, and/or other portions of blanks. Such panels, end flaps, and/or other portions of the blanks can be designated in relative terms to one another, e.g., “first”, “second”, “third”, etc., in sequential or non-sequential reference, without departing from the disclosure.

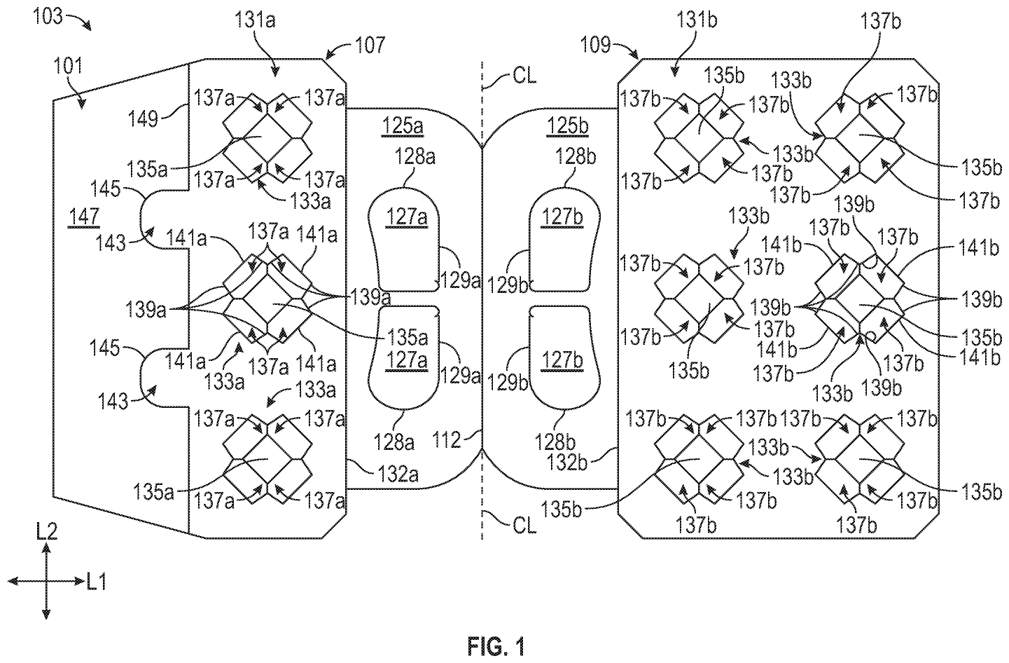

FIG. 1 shows a plan view of an exterior side 101 of a blank 103 used to form a carrier 105

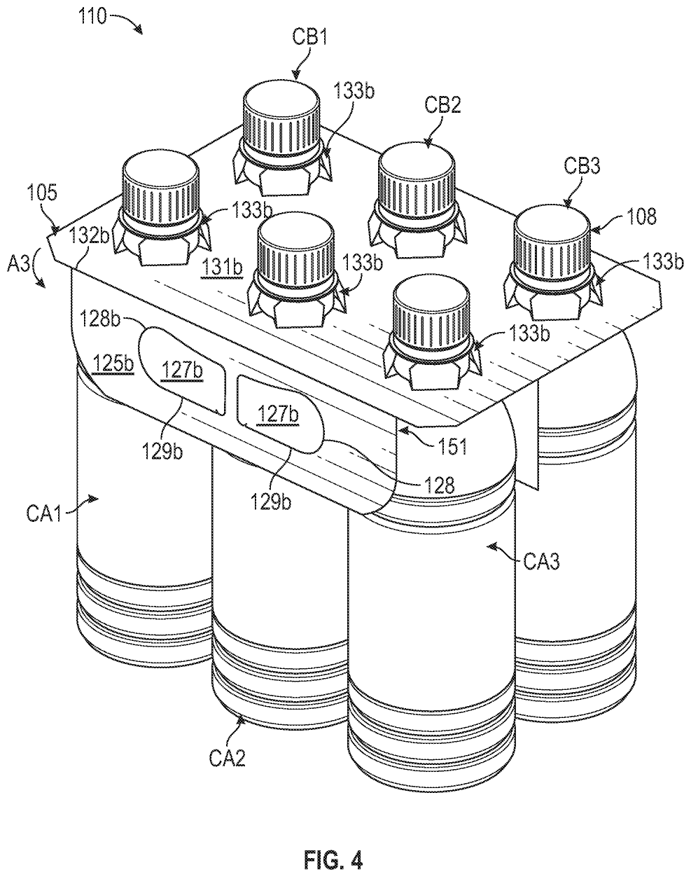

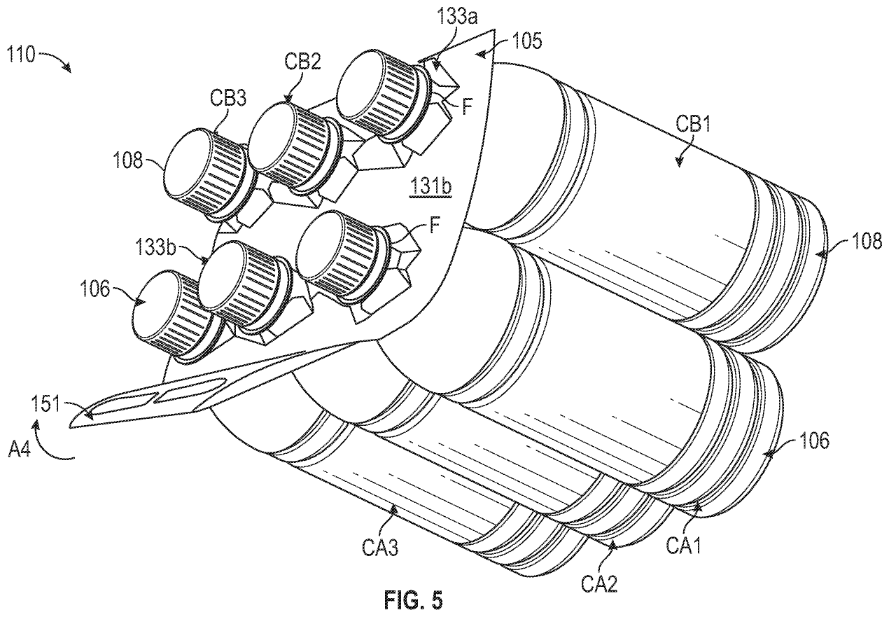

(FIG. 4) in accordance with a first exemplary embodiment of the disclosure. As shown in FIG. 5, the carrier 105 is sized to contain or support six containers, with three containers CA1, CA2, CA3 being attached to a front portion 106 of the carrier 105 and three containers CB1, CB2, CB3 being attached to a back portion 108 of the carrier 105. In the illustrated embodiment, the containers CA1, CA2, CA3, CB1, CB2, CB3 can be beverage bottles, for example, beverage bottles formed of a polymeric material such as polyethylene terephthalate (PET), with respective bottom portions B extending to a tapered upper neck portion N that terminates at a flange portion F upon which a cap CP is seated. The containers described herein could be any other suitable type and size of container without departing from the disclosure. The carrier 105 can be sized and shaped to hold more or less than six containers. In one embodiment, the front portion 106 and the back portion 108 of the carrier 105 each have three containers, and in other embodiments, the front portion 106 and the back portion 108 of the carrier 105 can carry more or less than three containers without departing from the disclosure. The carrier 105 can be provided together with one or more containers as a package 110 (FIG. 4).

As shown in FIG. 1, the blank 103 has a longitudinal axis L1 and a lateral axis L2. The blank 103 has a front portion 107 for forming the front portion 106 of the carrier 105, and a back portion 109 for forming the back portion 108 of the carrier 105. The front portion 107 and the back portion 109 of the blank 103 are foldably connected at a lateral fold line 112 that forms a lateral centerline CL of the blank 103, as shown. As discussed in further detail below, the blank 103 is partially formed into the carrier 105 by folding the blank 103 at the fold line 112 along the centerline CL so that the front portion 107 and the back portion 109 of the blank 103 are overlapped in at least partial face-to-face contact. It will be understood that the designations of the portions 107, 109 of the blank 103 and the portions 106, 108 of the carrier 105 as respective “front” and “back” portions can be reversed without departing from the disclosure.

In the illustrated embodiment, the front portion 107 of the blank 103 comprises a first or front handle panel 125a having a pair of handle flaps 127a at interior portions thereof, each defined by a respective cut 128a and each foldably connected to the handle panel 125a at respective lateral fold lines 129a. The respective cuts 128a and the respective handle flaps 127a formed therefrom include one or more curved and/or oblique portions and extend from one endpoint of the respective fold line 129a to the other endpoint of the respective fold line 129a, but can have a different configuration without departing from the disclosure.

A front container retention panel or front attachment panel 131a (broadly, “first attachment panel”) is foldably connected to the front handle panel 125a at a lateral fold line 132a, and includes container retention features 133a for at least partially receiving and engaging the respective flange portions F and/or neck portions N of one or more of the containers CA1, CA2, CA3. Each container retention feature 133a, as shown, includes a container receiving aperture or container receiving opening 135a that is defined by the arrangement of a plurality of container retention flaps 137a, each of which are defined by respective cuts 139a and are foldably connected to the attachment panel 131a at respective fold lines 141a. It will be understood that a different configuration of the container retention features 133a, such as a different number of container retention flaps 137a, or a different configuration of features, can be provided without departing from the disclosure.

As shown, a pair of tabs 143 protrudes longitudinally from the attachment panel 131a, and each tab 143 is laterally positioned between adjacent container retention features 133a. The tabs 143 are defined by respective generally U-shaped cuts 145 that interrupt the fold line 149. The tabs 143 could be otherwise shaped, arranged, configured, and/or omitted without departing from the disclosure.

A central panel or keel 147 is foldably connected to the attachment panel 131a at a lateral fold line 149 that is interrupted by the cuts 145. As described herein, the keel 147 is for positioning between the containers CA1, CA2, CA3 in the front portion 106 of the carrier 105 and the containers CB1, CB2, CB3 in the back portion 108 of the carrier 105. In this regard, in one embodiment, the keel 147 can be considered as distinct from the front portion 107 of the blank 3.

In the illustrated embodiment, the back portion 109 of the blank 103 includes a second or back handle panel 125b and a top panel or back container retention panel or back attachment panel 131b (broadly, “top container retention panel” or “top attachment panel” or “second attachment panel”) having associated features that are generally a mirror-image of the corresponding panels and flaps of the front portion 107 of the blank 103. Corresponding components (e.g., panels, flaps, fold lines, cuts, etc.) have been designated by corresponding reference numbers that differ by the “a” or “b” suffix, with the “a” components corresponding to the front portion 107 of the blank 103 and the “b” components corresponding to the back portion 109 of the blank 103.

The back attachment panel 131b, as shown, includes six container retention features 133b arranged in a 3×2 (3 longitudinal rows by 2 lateral columns) configuration. The back attachment panel 131b is free from attachment to a keel, although in alternative embodiments a keel can be provided and can be foldably connected to the back attachment panel 131b without departing from the disclosure.

Any of the panels, flaps, fold lines, cuts, or other features could be otherwise shaped, arranged, and/or omitted from the blank 103 without departing from the disclosure. The blank 103 could be sized and/or shaped to accommodate more or less than six containers without departing from this disclosure.

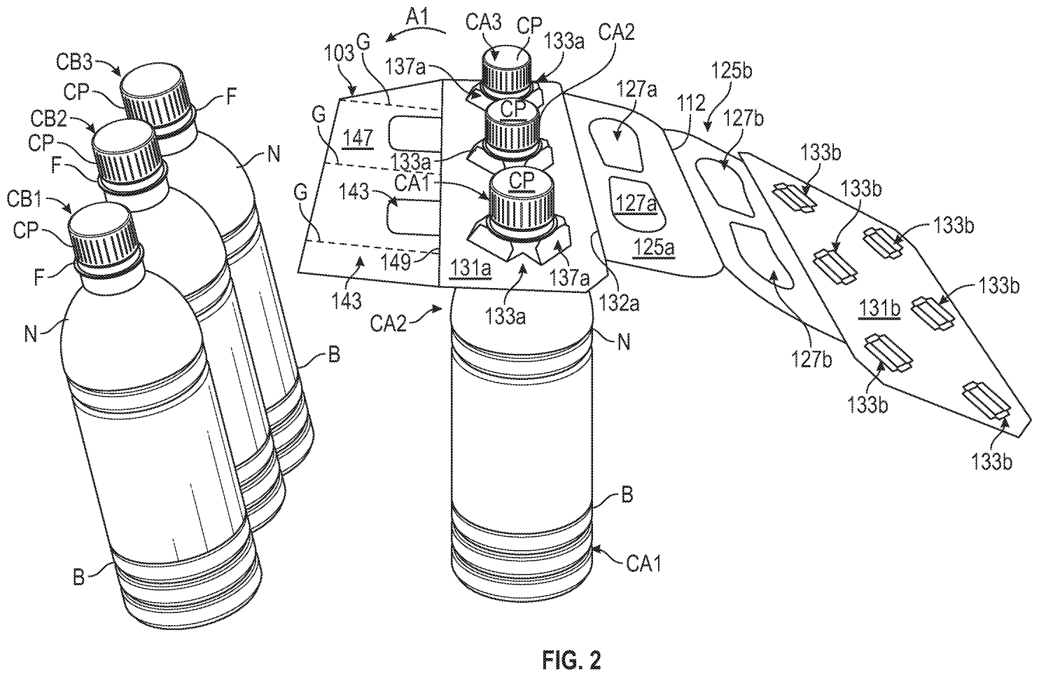

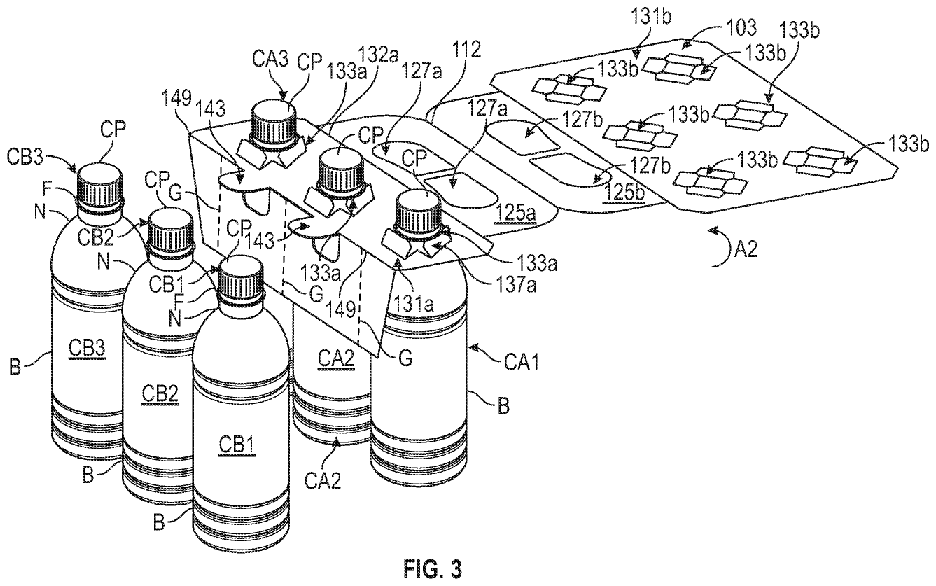

Referring additionally to FIGS. 2 and 3, formation of the carrier 105 from the blank 103 according to one embodiment of the disclosure will be described. As shown in FIG. 2, the front attachment panel 131a can be oriented with the exterior surface 101 facing downwardly and can be lowered or otherwise brought into engagement with the containers CA1, CA2, CA3 such that respective top portions thereof that include at least the respective caps CP and respective flange portions F are at least partially received through the respective openings 135a of the respective container retention features 133a. Such engagement of the container retention features 133a with the respective containers CA1, CA2, CA3 can cause the respective container retention flaps 137a to separate from the attachment panel 131a and/or each other at the respective cuts 139a and to fold upwardly at the respective fold lines 141a. In this regard, one or more of the container retention flaps 137a can rest against the neck portions N of the respective containers CA1, CA2, CA3, and distal edges thereof can be positioned to abut the respective flange portions F of the respective containers CA1, CA2, CA3. Portions of the container retention panel 131a adjacent the container retention flaps 137a can also be urged upwardly toward or into engagement with a portion of the respective containers CA1, CA2, CA3.

As shown, the keel 147 can be folded downwardly at the fold line 149 in the direction of the arrow A1 to extend into at least partial contact with a middle or bottom portion B of the respective containers CA1, CA2, CA3. The blank 103 can be provided with lines or other arrangements of glue G that are laterally aligned with the respective container retention features 133a so as to be positioned to align with the respective containers CA1, CA2, CA3. Accordingly, the keel 147 can be adhered to one or more of the containers CA1, CA2, CA3 by the contact of the glue G with the containers. The downward folding of the keel 147 away from the attachment panel 131a can also separate the container retention tabs 143 therefrom at the respective cuts 145 such that the tabs 143 are positioned to protrude outwardly from, and in generally planar relation with, the attachment panel 131a.

The glue G described herein can be, for example, a hot melt adhesive, a high tack glue, an epoxy, a polymeric cement, etc., or combinations thereof. While the interior surface of the keel 147 is illustrated as being provided with lines of glue G aligned with the respective containers CB1, CB2, CB3, it will be understood that the exterior surface of the keel 147 can be provided with lines of glue G aligned with the respective containers CA1, CA2, CA3.

The containers CB1, CB2, CB3 can be positioned to be in at least partial contact with the keel 147 opposite the respective containers CA1, CA2, CA3. In such an arrangement, one of the container retention tabs 143 can extend between the respective neck portions N of the containers CB1, CB2, and the other container retention tab 143 can extend between the respective neck portions N of the containers CB2, CB3, for example, to provide separation and/or lateral stability thereto. The tabs 143 can also engage an underside of the respective flange portions F of the respective containers CB1, CB2, CB3.

The back portion 109 of the blank 103 can be folded at the fold line 112 in the direction of the arrow A2 such that the handle panels 125a, 125b are in at least partial face-to-face contact and such that the attachment panel 131b overlies or is in at least partial face-to-face contact with the attachment panel 131a. In this regard, the first column of container retention features 133b overlie the container retention features 131a at the respective containers CA1, CA2, CA3, and the second column of container retention features 133b are further positioned to engage the respective containers CB1, CB2, CB3. The container retention features 133b engage the respective containers CA1, CA2, CA3, CB1, CB2, CB3 in a manner similar to that described above with respect to the container retention features 133a, e.g., such that the respective caps CP and/or flange portions F thereof extend through the openings 135b and such that the container retention flaps 137b foldably reconfigure to engage the respective necks N and/or flange portions F.

In the aforementioned arrangement, the portion of the attachment panel 131b that overlies the attachment panel 131a provides a reinforced engagement of the carrier 105 with the containers CA1, CA2, CA3 via a two-ply construction of the container retention features of the carrier 105 that include the container retention features 131a, 131b. Such reinforced engagement of the containers CA1, CA2, CA3 can provide, for example, sturdiness for shipping or incidental contact and/or resistance to tearing or inadvertent disengagement of containers from the carrier 105.

Referring additionally to FIG. 4, the handle panels 125a, 125b can together be folded downwardly at the respective fold lines 132a, 132b in the direction of the arrow A3 so as to rest against the containers CA1, CA2, CA3 and/or to be disposed in a generally parallel relation to the containers CA1, CA2, CA3, CB1, CB2, CB3 in a first configuration of the carrier 105, e.g., a storage and/or transport configuration of the carrier 105 that is provided with a compact and sleek profile. Further, the downwardly folded configuration of the handle panel 125b can provide a billboard or presentation surface that allows printing of indicia such as product advertising, labeling, promotional information, etc. on the external surface of the handle panel 125b that is readily visible to a consumer.

Turning to FIG. 5, the handle panels 125a, 125b can together be folded upwardly at the respective fold lines 132a, 132b in the direction of the arrow A4 so as to be in upwardly oblique or upright relation to the attachment panels 131a, 131b and to form a handle 151 for the carrier 105. Such an arrangement of the carrier 105 can be a second or carrying configuration of the carrier 105, in which the handle 151 is presented in a convenient orientation so as to be grasped by a consumer. A consumer can insert one or more fingers through handle openings formed by folding of the respective aligned handle flaps 127a, 127b at the respective fold lines 129a, 129b and such that the respective handle flaps 127a, 127b separate from the respective handle panels 125a, 125b at the respective cuts 128a, 128b. In this regard, the respective aligned handle flaps 127a, 127b can be folded into overlapping and/or at least partial face-to-face contact with the front handle panel 125a or the back handle panel 125b, for example, to provide a 4-ply structure with enhanced support and comfort to a consumer. It will be understood that the handle 151 can have a different configuration without departing from the disclosure.

Upon lifting or carrying of the carrier 105 by a consumer, the containers CA1, CA2, CA3 that are positioned closest to the handle 151 can at least partially rest upon the respective containers CB1, CB2, CB3 that are positioned farthest from the handle 151. Also, one or more of the containers CA1, CA2, CA3, CB1, CB2, CB3 are adhered to the keel 147 with glue G and are additionally secured to one or both of the attachment panels 131a, 131b through respective container retention features 133a, 133b.

The package 110 described above provides a carrier 105 with a compact structure that can, for example, provide materials savings and waste reduction. Additionally, the arrangement of the glue G between one or more of the containers CA1, CA2, CA3, CB1, CB2, CB3 and respective portions of the keel 147, in addition to the engagement of the container retention features 133a, 133b with the respective containers, provides multiple points of attachment that results in a robust structure for holding and carrying the containers CA1, CA2, CA3, CB1, CB2, CB3. Further, the exposure of one or more portions of the containers CA1, CA2, CA3, CB1, CB2, CB3 on exterior portions of the carrier 105/package 110 provides a viewer with a clear view of labeling or surface graphics associated with the containers CA1, CA2, CA3, CB1, CB2, CB3, as well as providing convenient access to remove one or more of the containers CA1, CA2, CA3, CB1, CB2, CB3 from the carrier 105/package 110, for example, by moving respective containers through the respective openings 135a, 135b of respective container retention features 133a, and peeling a respective container away from the keel 147.

Peeling or pulling a respective container away from the keel 147 can involve pulling the respective container with a force sufficient to overcome the adhesive bond of the respective container and the keel 147 provided by the glue G. In one embodiment, the glue G can be selected so as to remain on the keel 147, e.g., such that substantially little or no glue G remains on the container as it is removed. One or more of the containers CA1, CA2, CA3, CB1, CB2, CB3, in one embodiment, can be reattached to the keel 147 following therefrom by pressing the container against a respective region of glue G.

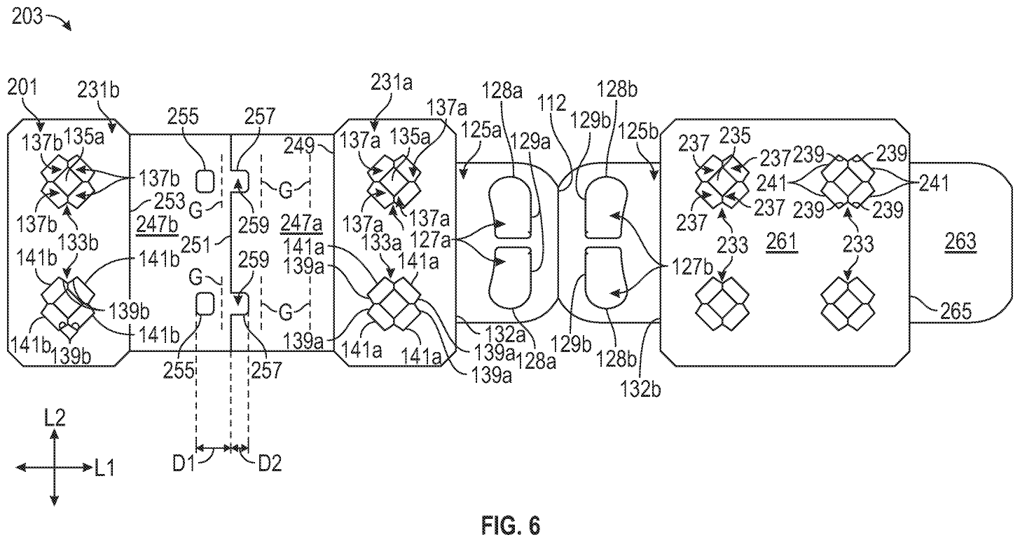

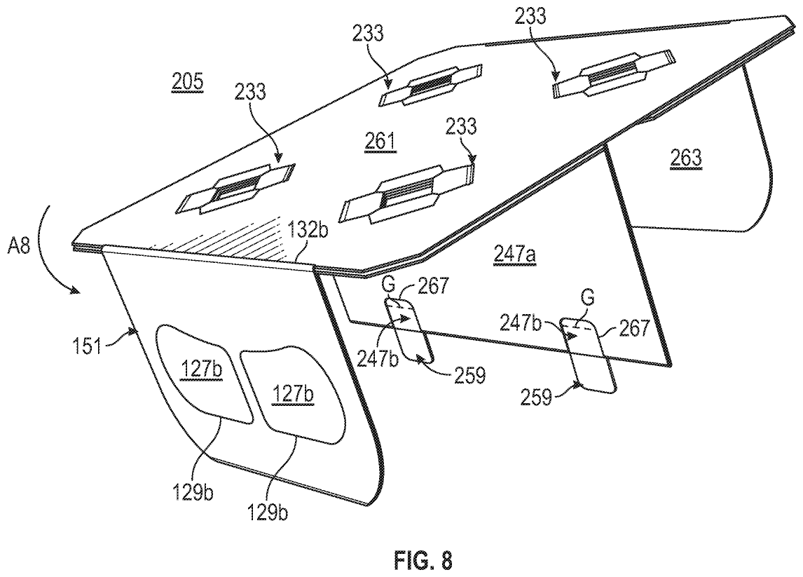

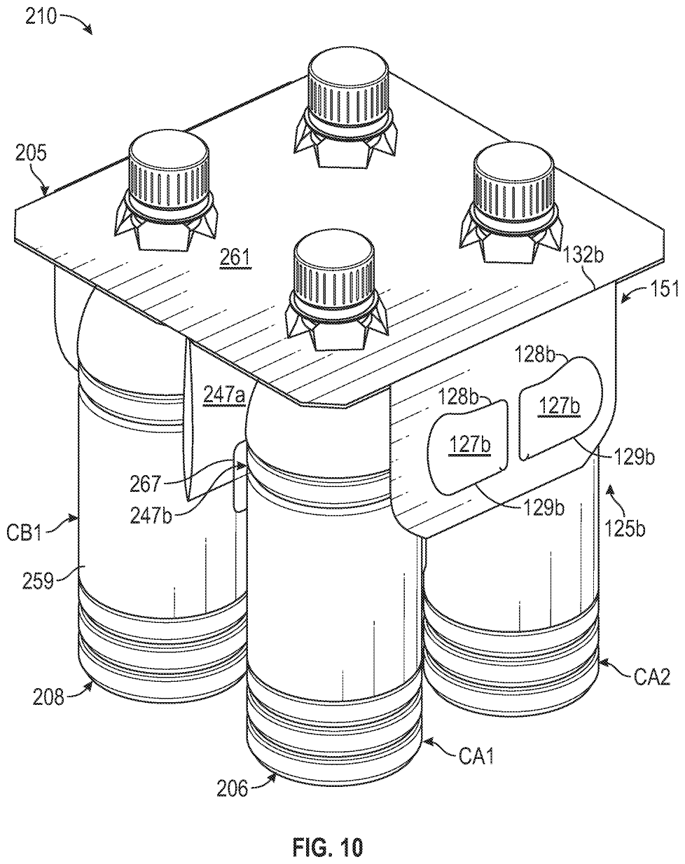

Referring to FIG. 6, an exterior surface 201 of a blank 203 for forming a carrier 205 (FIG. 8) is illustrated according to a second exemplary embodiment of the disclosure. The blank 203, carrier 205, and a package 210 (FIG. 10) including the carrier 205 and one or more containers, can have one or more features that are the same or similar to the blank 103, carrier 105, and package 110 of the first exemplary embodiment of the disclosure, and like or similar reference numbers are used to refer to like or similar elements thereof.

As shown, the blank 203 has a longitudinal axis L1 and a lateral axis L2, handle panels 125a, 125b (broadly, “first handle panel” and “second handle panel”, respectively) foldably connected at a fold line 112, a first or front attachment panel 231a foldably connected to the handle panel 125a at a fold line 132a and including a pair of laterally-spaced container retention features 133a, a front central panel or front keel 247a foldably connected to the front attachment panel 231a at a lateral fold line 249, a back central panel or back keel 247b foldably connected to the front keel 247a at a lateral fold line 251, and a second or back attachment panel 231b foldably connected to the back keel 247b at a lateral fold line 253 and including a pair of laterally-spaced container retention features 133b.

The back keel 247b can include a pair of laterally-spaced back glue openings 255 and a pair of laterally-spaced and generally U-shaped cuts 257 that interrupt the fold line 251 to define a pair of protruding tabs 259 extending toward the front keel 247a.

As shown, a reinforcing container retention panel or top container retention panel 261 is foldably connected to the handle panel 125b at a lateral fold line 132b, and includes a 2×2 arrangement of container retention features 233, each having a substantially similar configuration as the container retention features 133a, 133b, e.g., so as to have respective container receiving apertures or container receiving openings 235 and respective container retention flaps 237 formed by respective cuts 239 and being foldably connected to the top panel 261 at respective fold lines 241. In one embodiment, a billboard or back panel 263 is foldably connected to the top panel 261 at a lateral fold line 265, though the back panel 263 could be omitted without departing from the disclosure.

As also shown, glue G can be applied to one or more portions of the central panels 247a, 247b. While the glue G is illustrated on the exterior surface 201 of the blank 203 in FIG. 6 for clarity of illustration and to indicate positioning relative to other features of the blank 203, it will be understood that the glue G is applied to at least the interior surface of the central panels 247a, 247b. In one embodiment, glue G can be applied to both the interior surface and the exterior surface of the central panels 247a, 247b.

Any of the panels, flaps, fold lines, cuts, or other features could be otherwise shaped, arranged, and/or omitted from the blank 203 without departing from the disclosure. The blank 203 could be sized and/or shaped to accommodate a greater or fewer number of containers, e.g., by providing a different number of container retention features 133a, 133b, and/or 233, without departing from this disclosure.

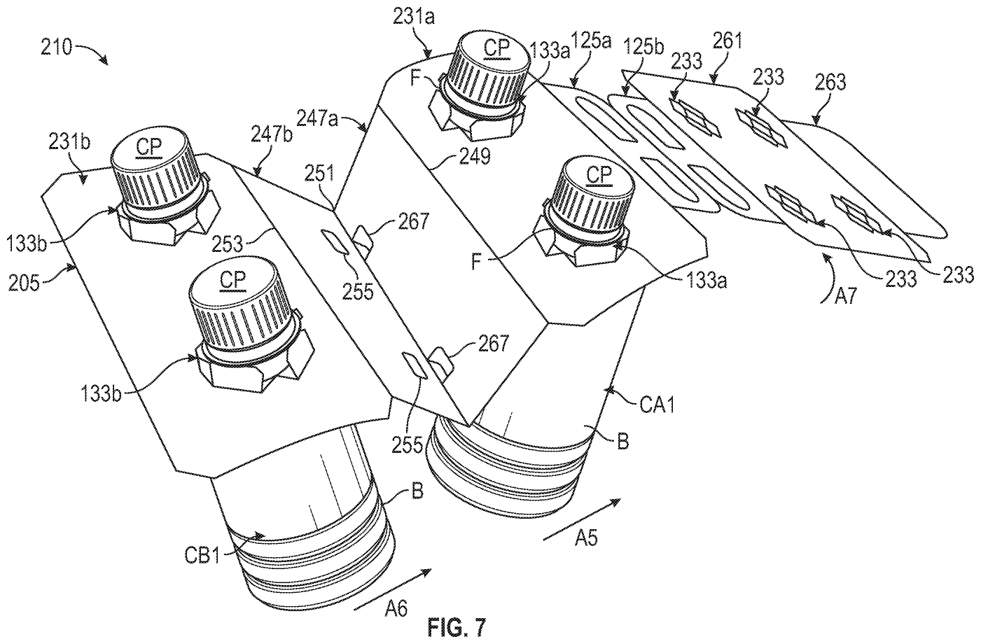

As shown in FIG. 7 (in which the glue G is omitted for clarity of illustration), the blank 203 can be oriented with the exterior surface 201 facing downwardly, and the front attachment panel 231a can be lowered or otherwise brought into engagement with the containers CA1, CA2 such that respective top portions thereof that include at least the respective caps CP and respective flange portions F extend through the respective openings 135a of the respective container retention features 133a as described above with respect to the carrier 105. Similarly, the back attachment panel 231b can be lowered or otherwise brought into engagement with the containers CB1, CB2 such that at least the respective caps CP and respective flange portions F extend through the respective openings 135b of the respective container retention features 133b.

As shown, the front keel 247a and the back keel 247b can be folded downwardly at the respective fold lines 249, 253 and folded at the fold line 251 to be brought into at least partial face-to-face contact in the direction of the respective arrows A5, A6 in the direction of the respective arrows A5, A6 such that the keels 247a, 247b also fold at the fold line 251 into at least partial face-to-face contact. Such folding can draw the containers CA1, CA2 and CB1, CB2 toward each other in an arrangement separated by the overlapped keels 247a, 247b to define a front portion 206 of the carrier 205 and a back portion 208 of the carrier 205.

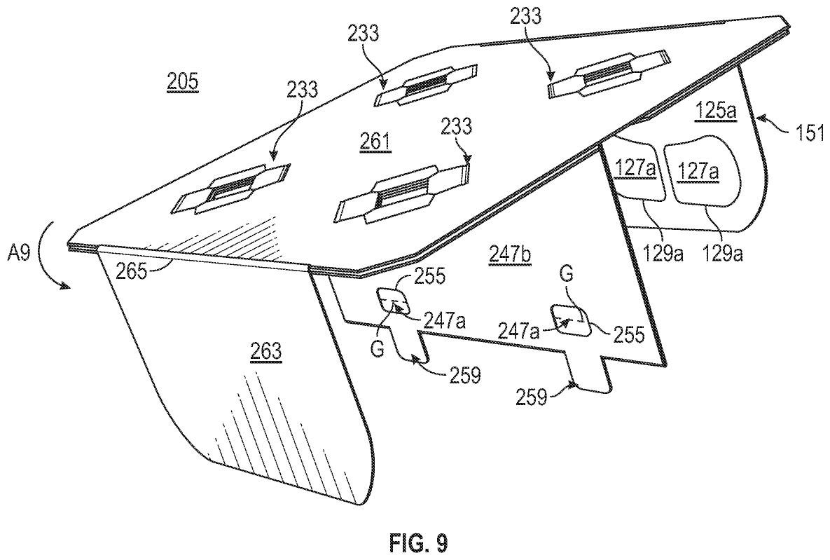

Upon folding of the keel 247b at the fold line 251, the tabs 259 can separate from the front keel 247a at the respective cuts 257 to extend in a generally downward arrangement and such that a pair of discontinuities or front glue openings 267 can be defined along the front keel 247a. In this regard, the glue openings 267 of the front keel 247a are positioned to be longitudinally offset from the glue openings 255 of the back keel 247b, with a top edge of the glue openings 255 of the back keel 247b spaced a greater longitudinal distance D1 (FIG. 6) from the fold line 251 than a longitudinal distance D2 (FIG. 6) from the fold line 251 at which a top edge of the glue openings 267 of the front keel 247a are positioned. In this regard, when the keels 247a, 247b are positioned in at least partial face-to-face contact, the glue openings 255 of the back keel 247b are positioned above the glue openings 267 of the front keel 247a such that the glue openings 267 expose respective portions of the back keel 247b and such that the glue openings 255 expose respective portions of the front keel 247a (shown best in FIGS. 8 and 9).

In the above-described arrangement, the lines or other arrangements of glue G (FIG. 6) disposed along the front keel 247a and exposed at the glue openings 267 can adhere the containers CA1, CA2 to respective exposed portions of the back keel 247b, and lines of glue G exposed at the glue openings 255 of the back keel 247b can also adhere the containers CB1, CB2 to respective exposed portions of the front keel 247a. The glue G can also maintain the keels 247a, 247b in at least partial-face-to-face contact. The glue G and/or the glue openings 255, 267 could be otherwise shaped, arranged, positioned, and/or configured without departing from the disclosure.

The attachment of the containers CA1, CA2, CB1, CB2 to the respective keels 247a, 247b can provide retention and support of the respective containers, e.g., such that the containers do not detach from the carrier 205 under their own weight, in addition to or alternative to the container retention and support provided by the respective container retention features. For example, in one embodiment, one or more of the containers CA1, CA2, CB1, CB2 can be attached to respective keels 247a, 247b with glue G, without additional retention and support provided by an attachment panel as described above.

Such enhanced attachment of the respective containers to the respective keels 247a, 247b with the glue G can also provide enhanced integrity to the carrier 205, e.g., by providing opposing adhesive forces on the respective keels 247a, 247b such that the keels 247a, 247b are compressed therebetween. For example, in one embodiment, as the carrier 205 is lifted, the containers CA1, CA2 can at least partially pull the portions of the back keel 247b to which they are attached through the respective glue openings 267 toward the front keel 247a under the at least partial weight of the containers CA1, CA2. Respective portions of the front keel 247a can be pulled toward the back keel 247b through the respective glue openings 255 by the containers CB1, CB2 in a similar manner.

Still referring to FIG. 7, and with additional reference to FIGS. 8 and 9 (in which the containers CA1, CA2, CB1, CB2 are removed for clarity of illustration), the handle panel 125b can be folded at the fold line 112 in the direction of the arrow A7 into at least partial face-to-face contact with the handle panel 125a, and such that the top container retention panel 261 is positioned in at least partial face-to-face contact with both of the attachment panels 231a, 231b, and such that the container retention features 233 overlie the respective container retention features 133a, 133b to receive and engage respective portions of the containers CA1, CA2, CB1, CB2 in a similar and reinforcing manner, e.g., such that the respective caps CP and/or flange portions F thereof extend through the openings 235 and such that the container retention flaps 237 foldably reconfigure to engage the respective necks N and/or flange portions F of the respective containers CA1, CA2, CB1, CB2. The top container retention panel 261 can be maintained in such an arrangement, for example, with an adhesive such as glue.

In the aforementioned arrangement, respective portions of the top container retention panel 261 overlie the respective attachment panels 231a, 231b to provide a reinforced engagement of the carrier 205 with the containers CA1, CA2, CB1, CB2 via a two-ply construction of the container retention features of the carrier 205 that include the container retention features 133a, 133b, 233. Such reinforced engagement of the containers CA1, CA2, CB1, CB2 can provide, for example, sturdiness for shipping or incidental contact and/or resistance to tearing or inadvertent disengagement of containers from the carrier 205.

As shown in FIG. 8, the handle panels 125a, 125b can together be folded downwardly at the respective fold lines 132a, 132b in the direction of the arrow A8 so as to rest against the containers CA1, CA2 and/or to be disposed in a generally parallel relation to the containers CA1, CA2, CB1, CB2 in a first configuration of the carrier 205, e.g., a storage and/or transport configuration of the carrier 205 that is provided with a compact and sleek profile. Further, the downwardly folded configuration of the handle 151 acts as a billboard or presentation surface that allows printing of indicia such as product advertising, labeling, promotional information, etc. on the external surface of the handle panel 125b and that is readily visible to a consumer. As shown in FIG. 9, the billboard 263 can also be folded downwardly at the fold line 265 in the direction of the arrow A9 to be in generally parallel relation with the keels 247a, 247b such that the billboard 263 can present such indicia to a consumer. The billboard 263 can also be adhered to one or more portions of the containers CB1, CB2 with an adhesive such as glue.

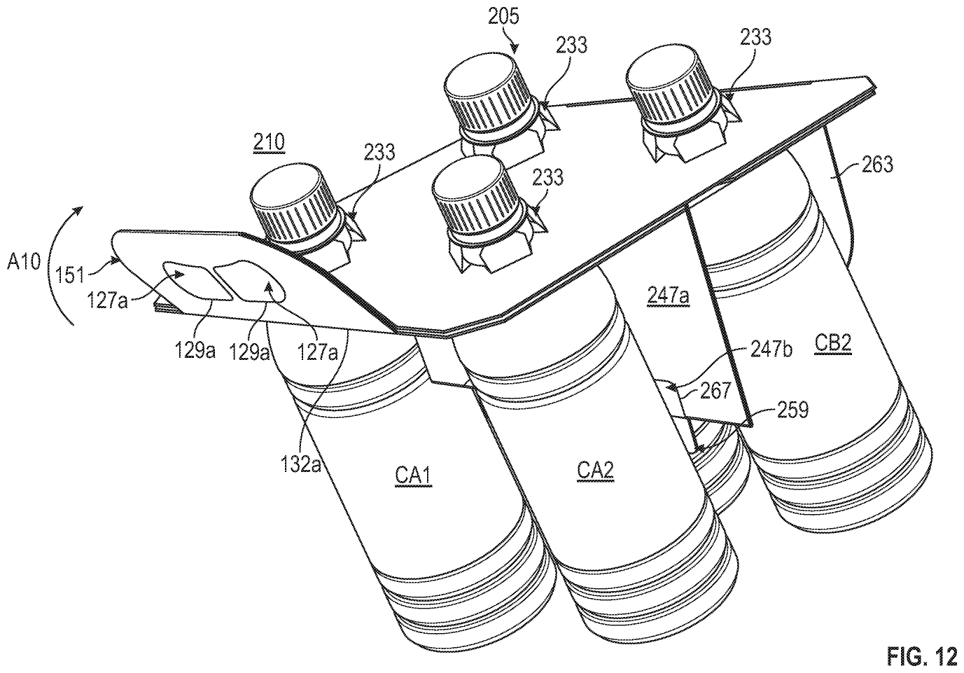

Turning to FIG. 12, the handle panels 125a, 125b can together be folded upwardly at the respective fold lines 132a, 132b in the direction of the arrow A10 so as to be in upwardly oblique or upright relation to the attachment panels 231a, 231b and to provide the handle 151 for the carrier 205. Such an arrangement can be a second or carrying configuration of the carrier 205, in which the handle 151 is presented in a convenient orientation so as to be grasped by a consumer. A consumer can insert one or more fingers through handle openings formed by folding of the respective aligned handle flaps 127a, 127b at the respective fold lines 129a, 129b and such that the respective handle flaps 127a, 127b separate from the respective handle panels 125a, 125b at the respective cuts 128a, 128b. In this regard, the respective aligned handle flaps 127a, 127b can be folded into overlapping and/or at least partial face-to-face contact with the front handle panel 125a or the back handle panel 125b, for example, to provide a 4-ply structure with enhanced support and comfort to a consumer. It will be understood that the handle 151 can have a different configuration without departing from the disclosure.

Upon lifting or carrying of the carrier 205 by a consumer, the containers CA1, CA2 that are positioned closest to the handle 151 can at least partially rest upon the respective containers CB1, CB2 that are positioned farthest from the handle 151. Also, the containers CA1, CA2, and CB1, CB2 are adhered to the keels 247a, 247b with glue G and are additionally secured to one or both of the attachment panels 231a, 231b through respective container retention features 133a, 133b, and 233.

The package 210 described above provides a carrier 205 with a compact structure that can, for example, provide materials savings and waste reduction. Additionally, the arrangement of the glue G between the containers CA1, CA2 and CB1, CB2 and respective portions of the keels 247a, 247b, in addition to the engagement of the container retention features 133a, 133b, 233 with respective containers provides multiple points of attachment that results in a robust structure for holding and carrying the containers CA1, CA2, CB1, CB2. Further, the exposure of one or more portions of the containers CA1, CA2, CB1, CB2 on exterior portions of the carrier 205/package 210 provides a consumer with a clear view of labeling or surface graphics associated with the containers CA1, CA2, CB1, CB2 as well as providing convenient access to remove one or more of the containers CA1, CA2, CB1, CB2 from the carrier 205/package 210, for example, by moving respective containers through the respective openings 135a, 135b, 235 of respective container retention features 133a, 133b, 233, and peeling a respective container away from the keels 247a, 247b as described above. The carrier 205/package 210 is sized to hold four containers CA1, CA2, CB1, CB2 in a 2x2 arrangement, but the carrier 205/package 210 could be otherwise shaped and configured to hold more or less than four containers in an alternative arrangement without departing from the scope of the disclosure.

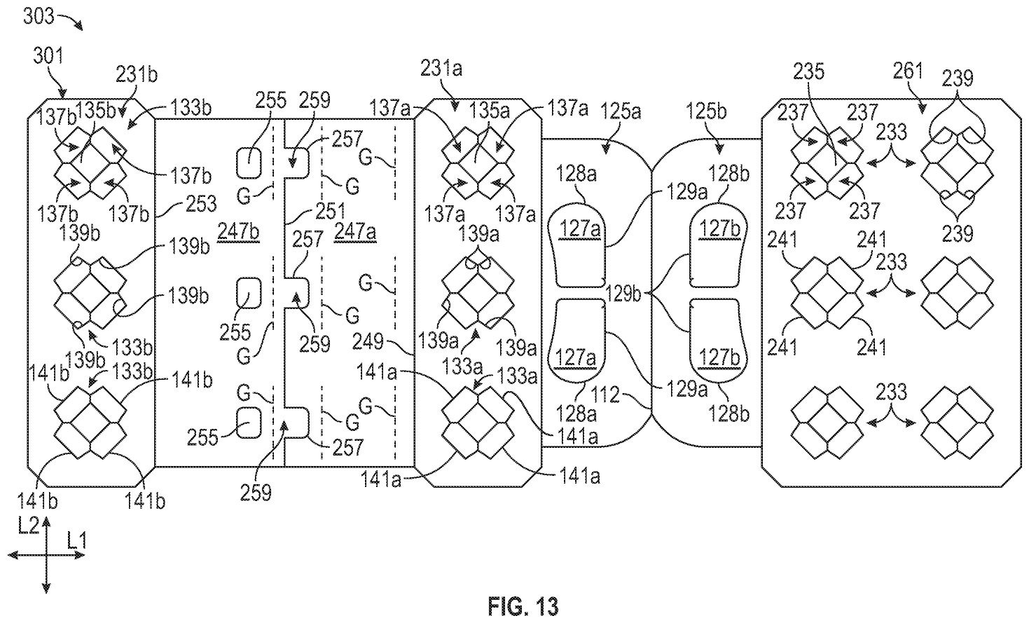

Turning to FIG. 13, an exterior surface 301 of a blank 303 for forming a carrier according to a third exemplary embodiment of the disclosure is illustrated. The blank 303 may have one or more features that are similar to those of the blanks 103, 203 described above, and like or similar reference numbers are provided for like or similar features.

For example, the blank 303 can be substantially similar to the blank 203 described above, except that each of the front attachment panel 231a and the back attachment panel 231b is provided with a respective set of three-laterally spaced container retention features 133a, 133b, and the top panel 261 is provided with a 3×2 (three longitudinal rows by two lateral columns) arrangement of container retention features 233. A different number or arrangement of container retention features can be provided without departing from the disclosure.

In addition, the blank 303 is illustrated as free from a billboard, though it will be understood that a billboard, such as the billboard 263, or other arrangement of billboard or attachment panel can be provided without departing from the disclosure. The carrier/package formed from the blank 303 is configured for holding six containers in a 3×2 arrangement, but the carrier/package could be otherwise shaped and configured to hold more or less than six containers in an alternative arrangement without departing from the scope of the disclosure.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for holding a plurality of containers, the carrier comprising:
a plurality of panels, the plurality of panels comprising:
at least one central panel for being attached to at least one container of the plurality of containers; and
at least one attachment panel foldably connected to the at least one central panel, the at least one attachment panel comprises a plurality of container retention features for at least partially receiving a top portion of a respective container of the plurality of containers; and
at least one handle panel foldably connected to the at least one central panel for forming a handle of the carrier.

2. The carrier of claim 1, wherein the plurality of container retention features comprises a plurality of container retention flaps foldably connected to the at least one attachment panel.

3. The carrier of claim 2, wherein the plurality of container retention flaps are arranged to define a container receiving opening therebetween.

4. The carrier of claim 1, wherein the at least one attachment panel comprises a first attachment panel and the at least one handle panel comprises a first handle panel, and the plurality of panels comprises a second handle panel foldably connected to the first handle panel and a second attachment panel foldably connected to the second handle panel.

5. The carrier of claim 4, wherein the second attachment panel is in at least partial face-to-face contact with the first attachment panel and the second handle panel is in at least partial face-to-face contact with the first handle panel.

6. The carrier of claim 1, wherein the at least one central panel comprises at least one glue opening.

7. The carrier of claim 6, wherein the at least one central panel is a front central panel, and the plurality of panels further comprises a back central panel foldably connected to the front central panel, the at least one glue opening is an at least one front glue opening in the front central panel, and the back central panel comprises at least one back glue opening.

8. The carrier of claim 7, wherein the front central panel is foldably connected to the back central panel at a fold line, the fold line is interrupted by at least one cut that at least partially defines the at least one front glue opening.

9. The carrier of claim 8, wherein the front central panel is in at least partial face-to-face contact with the back central panel such that a portion of the back central panel is exposed through the at least one front glue opening and a portion of the front central panel is exposed through the at least one back glue opening.

10. The carrier of claim 1, wherein the at least one central panel is a front central panel and the plurality of panels further comprises a back central panel foldably connected to the front central panel, the at least one attachment panel is a front attachment panel foldably connected to the front central panel, the plurality of container retention features are a plurality of front container retention features in the front attachment panel, and the plurality of panels further comprises a back attachment panel foldably connected to the back central panel and comprising a plurality of back container retention features for at least partially receiving the top portion of the respective container.

11. The carrier of claim 10, wherein the plurality of panels further comprises a top attachment panel foldably connected to the at least one handle panel, the top attachment panel comprises a plurality of top container retention features for at least partially receiving the respective top portion of the respective container.

12. The carrier of claim 11, wherein the top attachment panel is in at least partial face-to-face contact with at least one of the front attachment panel and the back attachment panel such that at least one container retention feature of the plurality of container retention features has a two-ply configuration.

13. The carrier of claim 11, wherein the top attachment panel is in at least partial face-to-face contact with each of the front attachment panel and the back attachment panel such that at least one container retention feature of each of the plurality of front container retention features and the plurality of back container retention features has a two-ply configuration.

14. The carrier of claim 11, wherein the at least one handle panel is a front handle panel and the plurality of panels further comprises a back handle panel foldably connected to the front handle panel, the front handle panel and the back handle panel are in at least partial face-to-face contact to form the handle of the carrier.

15. The carrier of claim 14, wherein each of the front handle panel and the back handle panel comprises a respective at least one handle reinforcement flap foldably connected to the respective front handle panel and the back handle panel.

16. The carrier of claim 1, wherein the at least one central panel is foldably connected to the at least one attachment panel at a fold line, the fold line is interrupted by at least one cut to define at least one container retention tab protruding from the at least one attachment panel and for extending between respective neck portions of respective adjacent containers of the plurality of containers.

17. A blank for forming a carrier for holding a plurality of containers, the blank comprising:
a plurality of panels, the plurality of panels comprising:
at least one central panel for being attached to at least one container of the plurality of containers when the carrier is formed from the blank; and
at least one attachment panel foldably connected to the at least one central panel, the at least one attachment panel comprises a plurality of container retention features for at least partially receiving a top portion of a respective container of the plurality of containers when the carrier is formed from the blank; and
at least one handle panel foldably connected to the at least one central panel for forming a handle of the carrier formed from the blank.

18. The blank of claim 17, wherein the plurality of container retention features comprises a plurality of container retention flaps foldably connected to the at least one attachment panel.

19. The blank of claim 18, wherein the plurality of container retention flaps are arranged to define a container receiving opening therebetween.

20. The blank of claim 17, wherein the at least one attachment panel comprises a first attachment panel and the at least one handle panel comprises a first handle panel, and the plurality of panels comprises a second handle panel foldably connected to the first handle panel and a second attachment panel foldably connected to the second handle panel.

21. The blank of claim 20, wherein the second attachment panel is for being positioned in at least partial face-to-face contact with the first attachment panel and the second handle panel is for being positioned in at least partial face-to-face contact with the first handle panel when the carrier is formed from the blank.

22. The blank of claim 17, wherein the at least one central panel comprises at least one glue opening.

23. The blank of claim 22, wherein the at least one central panel is a front central panel, and the plurality of panels further comprises a back central panel foldably connected to the front central panel, the at least one glue opening is an at least one front glue opening in the front central panel, and the back central panel comprises at least one back glue opening.

24. The blank of claim 23, wherein the front central panel is foldably connected to the back central panel at a fold line, the fold line is interrupted by at least one cut that at least partially defines the at least one front glue opening.

25. The blank of claim 24, wherein the front central panel is for being positioned in at least partial face-to-face contact with the back central panel when the carrier is formed from the blank such that a portion of the back central panel is exposed through the at least one front glue opening and a portion of the front central panel is exposed through the at least one back glue opening.

26. The blank of claim 17, wherein the at least one central panel is a front central panel and the plurality of panels further comprises a back central panel foldably connected to the front central panel, the at least one attachment panel is a front attachment panel foldably connected to the front central panel, the plurality of container retention features are a plurality of front container retention features in the front attachment panel, and the plurality of panels further comprises a back attachment panel foldably connected to the back central panel and comprising a plurality of back container retention features.

27. The blank of claim 26, wherein the plurality of panels further comprises a top attachment panel foldably connected to the at least one handle panel, the top attachment panel comprises a plurality of top container retention features.

28. The blank of claim 27, wherein the at least one handle panel is a front handle panel and the plurality of panels further comprises a back handle panel foldably connected to the front handle panel, the front handle panel and the back handle panel are for being positioned in at least partial face-to-face contact to form the handle of the carrier formed from the blank.

29. The blank of claim 28, wherein each of the front handle panel and the back handle panel comprises a respective at least one handle reinforcement flap foldably connected to the respective front handle panel and the back handle panel.

30. The blank of claim 17, wherein the at least one central panel is foldably connected to the at least one attachment panel at a fold line, the fold line is interrupted by at least one cut to define at least one container retention tab protruding from the at least one attachment panel.

31. A method of forming a carrier for holding a plurality of containers, the method comprising:
obtaining a blank comprising a plurality of panels, the plurality of panels comprising:
at least one central panel;
at least one attachment panel foldably connected to the at least one central panel, the at least one attachment panel comprises a plurality of container retention features; and
at least one handle panel foldably connected to the at least one central panel for forming a handle of the carrier;
folding the plurality of panels such that the at least one central panel is positioned between adjacent containers of the plurality of containers; and
attaching the at least one central panel to at least one container of the plurality of containers.

32. The method of claim 31, wherein the plurality of container retention features comprises a plurality of container retention flaps foldably connected to the at least one attachment panel.

33. The method of claim 32, wherein the plurality of container retention flaps are arranged to define a container receiving opening therebetween.

34. The method of claim 31, wherein the at least one attachment panel comprises a first attachment panel and the at least one handle panel comprises a first handle panel, and the plurality of panels comprises a second handle panel foldably connected to the first handle panel and a second attachment panel foldably connected to the second handle panel.

35. The method of claim 34, wherein the second attachment panel is in at least partial face-to-face contact with the first attachment panel and the second handle panel is in at least partial face-to-face contact with the first handle panel.

36. The method of claim 31, wherein the at least one central panel comprises at least one glue opening.

37. The method of claim 36, wherein the at least one central panel is a front central panel, and the plurality of panels further comprises a back central panel foldably connected to the front central panel, the at least one glue opening is an at least one front glue opening in the front central panel, and the back central panel comprises at least one back glue opening.

38. The method of claim 37, wherein the front central panel is foldably connected to the back central panel at a fold line, the fold line is interrupted by at least one cut that at least partially defines the at least one front glue opening.

39. The method of claim 38, wherein the front central panel is in at least partial face-to-face contact with the back central panel such that a portion of the back central panel is exposed through the at least one front glue opening and a portion of the front central panel is exposed through the at least one back glue opening.

40. The method of claim 31, wherein the at least one central panel is a front central panel and the plurality of panels further comprises a back central panel foldably connected to the front central panel, the at least one attachment panel is a front attachment panel foldably connected to the front central panel, the plurality of container retention features are a plurality of front container retention features in the front attachment panel, and the plurality of panels further comprises a back attachment panel foldably connected to the back central panel and comprising a plurality of back container retention features for at least partially receiving the top portion of the respective container.

41. The method of claim 40, wherein the plurality of panels further comprises a top attachment panel foldably connected to the at least one handle panel, the top attachment panel comprises a plurality of top container retention features for at least partially receiving the respective top portion of the respective container.

42. The method of claim 41, wherein the top attachment panel is in at least partial face-to-face contact with at least one of the front attachment panel and the back attachment panel such that at least one container retention feature of the plurality of container retention features has a two-ply configuration.

43. The method of claim 41, wherein the top attachment panel is in at least partial face-to-face contact with each of the front attachment panel and the back attachment panel such that at least one container retention feature of each of the plurality of front container retention features and the plurality of back container retention features has a two-ply configuration.

44. The method of claim 41, wherein the at least one handle panel is a front handle panel and the plurality of panels further comprises a back handle panel foldably connected to the front handle panel, the front handle panel and the back handle panel are in at least partial face-to-face contact to form the handle of the carrier.

45. The method of claim 44, wherein each of the front handle panel and the back handle panel comprises a respective at least one handle reinforcement flap foldably connected to the respective front handle panel and the back handle panel.

46. The method of claim 31, wherein the at least one central panel is foldably connected to the at least one attachment panel at a fold line, the fold line is interrupted by at least one cut to define at least one container retention tab protruding from the at least one attachment panel and for extending between respective neck portions of respective adjacent containers of the plurality of containers.

47. A package comprising:
a plurality of containers; and
a carrier holding the plurality of containers, the carrier comprising:
a plurality of panels, the plurality of panels comprising:
at least one central panel attached to at least one container of the plurality of containers; and
at least one attachment panel foldably connected to the at least one central panel, the at least one attachment panel comprises a plurality of container retention features at least partially receiving a top portion of a respective container of the plurality of containers; and
at least one handle panel foldably connected to the at least one central panel for forming a handle of the carrier.

48. The package of claim 47, wherein the plurality of container retention features comprises a plurality of container retention flaps foldably connected to the at least one attachment panel.

49. The package of claim 48, wherein the plurality of container retention flaps are arranged to define a container receiving opening therebetween.

50. The package of claim 47, wherein the at least one attachment panel comprises a first attachment panel and the at least one handle panel comprises a first handle panel, and the plurality of panels comprises a second handle panel foldably connected to the first handle panel and a second attachment panel foldably connected to the second handle panel.

51. The package of claim 50, wherein the second attachment panel is in at least partial face-to-face contact with the first attachment panel and the second handle panel is in at least partial face-to-face contact with the first handle panel.

52. The package of claim 47, wherein the at least one central panel comprises at least one glue opening.

53. The package of claim 52, wherein the at least one central panel is a front central panel, and the plurality of panels further comprises a back central panel foldably connected to the front central panel, the at least one glue opening is an at least one front glue opening in the front central panel, and the back central panel comprises at least one back glue opening.

54. The package of claim 53, wherein the front central panel is foldably connected to the back central panel at a fold line, the fold line is interrupted by at least one cut that at least partially defines the at least one front glue opening.

55. The package of claim 52, wherein the front central panel is in at least partial face-to-face contact with the back central panel such that a portion of the back central panel is exposed through the at least one front glue opening and a portion of the front central panel is exposed through the at least one back glue opening.

56. The package of claim 47, wherein the at least one central panel is a front central panel and the plurality of panels further comprises a back central panel foldably connected to the front central panel, the at least one attachment panel is a front attachment panel foldably connected to the front central panel, the plurality of container retention features are a plurality of front container retention features in the front attachment panel, and the plurality of panels further comprises a back attachment panel foldably connected to the back central panel and comprising a plurality of back container retention features at least partially receiving the top portion of the respective container.

57. The package of claim 56, wherein the plurality of panels further comprises a top attachment panel foldably connected to the at least one handle panel, the top attachment panel comprises a plurality of top container retention features at least partially receiving the respective top portion of the respective container.

58. The package of claim 57, wherein the top attachment panel is in at least partial face-to-face contact with at least one of the front attachment panel and the back attachment panel such that at least one container retention feature of the plurality of container retention features has a two-ply configuration.

59. The package of claim 57, wherein the top attachment panel is in at least partial face-to-face contact with each of the front attachment panel and the back attachment panel such that at least one container retention feature of each of the plurality of front container retention features and the plurality of back container retention features has a two-ply configuration.

60. The package of claim 57, wherein the at least one handle panel is a front handle panel and the plurality of panels further comprises a back handle panel foldably connected to the front handle panel, the front handle panel and the back handle panel are in at least partial face-to-face contact to form the handle of the carrier.

61. The package of claim 60, wherein each of the front handle panel and the back handle panel comprises a respective at least one handle reinforcement flap foldably connected to the respective front handle panel and the back handle panel.

62. The package of claim 47, wherein the at least one central panel is foldably connected to the at least one attachment panel at a fold line, the fold line is interrupted by at least one cut to define at least one container retention tab protruding from the at least one attachment panel and for extending between respective neck portions of respective adjacent containers of the plurality of containers.
